(19) United States
(12) Patent Application Publication
(10) Pub. No.: US 2008/0178713 A1
(43) Pub. Date: Jul. 31, 2008

(54) Fastener tightening system utilizing identification technology

(76) Inventors: Robert Earl Long, Tremont, IL (US); Jeffrey P. Nash, Peoria, IL (US); Nanda Kishore Venkata Sukhavasi, Peoria, IL (US); John Roley, Metamora, IL (US)

Correspondence Address: CATERPILLAR/FINNEGAN, HENDERSON, L.L.P., 901 New York Avenue, NW, WASHINGTON, DC, 20001-4413, US

(21) Appl. No.: 11/700,104

(22) Filed: Jan. 31, 2007

(51) Int. Cl. B25B 23/14

(52) U.S. Cl. 81/467; 73/862.21

(57) ABSTRACT

In one aspect, the present disclosure is directed toward a fastener tightening system. The system has a tightening tool configured to apply a torque to a fastener. Additionally, the system has a fastener data storage device located on the fastener and configured to store data related to the associated fastener. The system further has at least one component data storage device located on a component receiving the fastener to store data related to a tightening process. A data sensor is also included and is configured to sense data stored on the fastener data storage device and the at least one component data storage device. The system also has a controller configured to regulate operation of the tightening tool based on the sensed data and the sensed parameter.

### TECHNICAL FIELD

The present disclosure is directed to a fastener tightening system, and more particularly, to a fastener tightening system that utilizes identification technology.

### BACKGROUND

Conventional manufacturing processes typically involve the assembly of individual components into a finished product. Depending on the intended use of the components and type of joints formed during assembly, several methods and devices can be employed to secure the individual components together. Among the devices commonly used to combine components are mechanical fasteners. Mechanical fasteners grip two or more of the components and effectively use compressive forces to minimize movement between the components.

The strength of joints secured by mechanical fasteners is dependant upon the magnitude of the overall compressive forces applied to the joint, as well as the degree to which the compressive forces acting on the joint are distributed. For example, the joint is strongest when the overall compressive force acting on the joint is evenly distributed over the surfaces of the joined components.

In many applications, the components must be secured together by a predetermined compressive force with each fastener being tightened to a predetermined axial load that prevents joint failure. Unfortunately, when joints are secured by multiple fasteners, the act of tightening one fastener can affect the compressive force applied to the joint by another already-tightened fastener. For example, if a first fastener is already tightened to a desired axial load, tightening a second fastener may decrease the axial load of the first fastener, thereby reducing the strength of the joint and increasing the possibility that the joint may fail.

U.S. Pat. No. 7,096,569 issued to Barr et al. (Barr) on Aug. 29, 2006, discloses an assembly system that ensures a joint is secured together with a predetermined compressive force by applying a predetermined torque to a set of fasteners. In Barr, the assembly system is provided with a controller, a plurality of sensors, and an assembly station having a tightening tool. The system utilizes the sensors to locate and situate the parts to be assembled in the assembly station. Data is supplied to the controller containing identification of the components, assembly procedures for the components, the number of fasteners required by each component, and the magnitude of torque to be applied to each fastener. Before energizing the tightening tool, a socket component to be installed on the tightening tool is selected to match the size and torque requirements of the fasteners. Because the torque setting of the tightening tool is based on the particular socket component being used, multiple socket components are necessary in circumstances where the selected fasteners require differing torques. As the components are positioned for assembly, fasteners are located at the appropriate positions for installation, and the controller energizes the tightening tool. Once energized, the tightening tool applies a preset torque to the fasteners in a specified order.

Although the system in Barr may improve the integrity of a clamped joint by automatically applying a predetermined torque to each fastener in a specified order, the resulting joint may still be sub-optimal. That is, the axial loads acting on the fasteners may be inconsistent throughout the joint, and the overall compressive force may be greater than or less than a desired compressive force. In particular, the Barr system only verifies the torque applied to each fastener and does not account for axial load changes that occur after the fastener has been tightened. Such changes in axial load may be caused by the subsequent tightening of other fasteners in the same assembly.

Additionally, although the system in Barr may be capable of applying torques of different magnitudes to different fasteners in the same assembly, this capability only applies to fasteners having different sizes. Each socket component has only one torque applying capability, which can be utilized for only one size of fastener at a time. Therefore, fasteners having the same size but requiring different torques cannot be accommodated by the Barr system, unless a different socket of the same size is selected. This limitation may result in unwanted complexity and increased cost.

Furthermore, although the system in Barr may be able to distinguish between fasteners having different sizes, other fastener characteristics are not identified by the system. Because of this, the system may be prone to manufacturing errors such as, for example, mistakenly installing fasteners with a threading geometry incompatible with the components being installed. Additional assembly errors may include, for example, mistakenly installing fasteners manufactured from inappropriate materials that may perform poorly in the intended application.

The disclosed tightening system is directed to overcoming one or more of the problems set forth above.

### SUMMARY OF THE INVENTION

In one aspect, the present disclosure is directed toward a fastener tightening system. The system includes a tightening tool configured to apply a torque to a fastener. Additionally, the system includes a fastener data storage device located on the fastener and configured to store data related to the associated fastener. The system further includes at least one component data storage device located on a component receiving the fastener to store data related to a tightening process. A data sensor is also included and configured to sense data stored on the fastener data storage device and the at least one component data storage device. The system also includes a controller configured to regulate operation of the tightening tool based on the sensed data and the sensed parameter.

Consistent with a further aspect of the disclosure, a method is provided for tightening a fastener. The method includes reading data stored on a component and a fastener, and applying a first torque to the fastener based on the read data. The method further includes adjusting the magnitude of the applied first torque based on the read data. The method also includes applying a subsequent torque to the fastener based on the read data, and adjusting the magnitude of the applied subsequent torque based on the read data.

### BRIEF DESCRIPTION OF THE DRAWINGS

FIG. 1 is a diagrammatic illustration of a component assembly system according to an exemplary disclosed embodiment;

FIG. 2 is a diagrammatic illustration of an assembly component according to an exemplary disclosed embodiment;

FIG. 3A is a diagrammatic illustration of a fastener according to an exemplary disclosed embodiment;

FIG. 3B is a diagrammatic illustration of a fastener according to another exemplary disclosed embodiment;

FIG. 4 is a flow diagram of a method according to an exemplary disclosed embodiment; and

FIG. 5 is a graphical illustration of a communication to an operator according to an exemplary disclosed embodiment.

### DETAILED DESCRIPTION

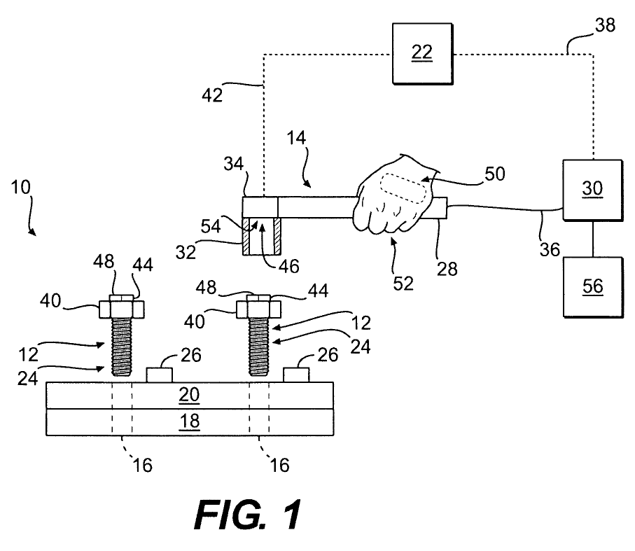

FIG. 1 provides a diagrammatic perspective of a component assembly station 10 according to an exemplary embodiment. Component assembly station 10 may be used to secure individual components together to create a finished product via one or more mechanical fasteners 12. Such finished products may include, for example, engine assemblies, engine exhaust assemblies, construction equipment, or any other finished product known in the art requiring threaded fasteners to secure individual components together. Mechanical fasteners 12 may be, for example, screws, bolts, threaded studs or lugs, or any other mechanical fastener known in the art. Component assembly station 10 may include a tightening tool 14 for tightening fasteners 12 into mating holes 16 of first and second components 18, 20, and a controller 22 for regulating the operation of tightening tool 14. It should be understood that although the exemplary embodiment illustrated in FIG. 1 discloses two components to be assembled, assembly station 10 can be utilized to simultaneously assemble any number of components.

While positioned for assembly, first and second components 18, 20 may receive fasteners 12 through mating holes 16. Mating holes 16 may be sized to have approximately the same diameter as a rod portion 24 of fasteners 12. Although mating holes 16 are disclosed to extend through the entire depth of first and second components 18, 20, mating holes 16 may alternatively extend only partially rather than completely through first component 18. Furthermore, the threading geometry of mating holes 16 may be required to match the threading geometry of rod portions 24. In addition to mating holes 16, first or second components 18, 20 may include at least one component data storage device 26. It is contemplated that mating holes 16 that extend through component 20 may be clearance holes without threading, if desired. In such embodiment, mating holes 16 extending through component 20 may have a larger diameter than mating holes 16 extending through component 18.

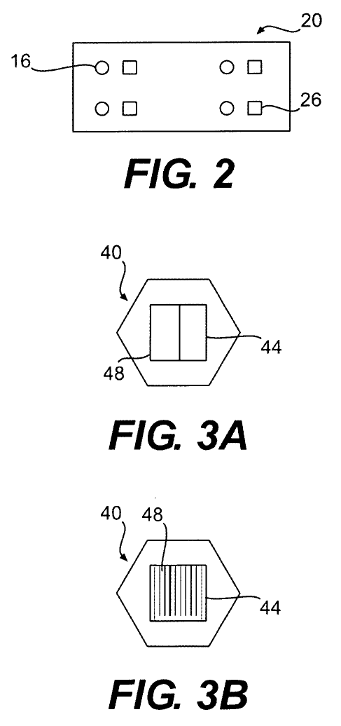

Each component data storage device 26 may be located adjacent to an associated mating hole 16 and contain data related to the assembly of first and second components 18, 20. Such data may include, for example, identification of the associated first and second component 18, 20, identification of associated mating hole 16, type of fastener 12 to be positioned at associated mating hole 16, identification of all other mating holes 16 located on the associated component, the type of fastener 12 to be positioned at other mating holes 16, a sequence in which torque may be applied to multiple fasteners 12, an axial load to which each fastener 12 may be tightened, and any other factor that may facilitate the assembly process. Component data storage device 26 may be a radio frequency identification device (RFID) or indicia, such as, for example, a barcode. As illustrated in FIG. 2, component data storage device 26 may be an independent element located adjacent to mating hole 16. In an alternate embodiment, component data storage device 26 may be a series of non-repeating segments of code associated with the information described above and may be etched into a top layer of the associated first and/or second component 18, 20. In addition, each segment of code may correspond to a different factor related to the tightening of fasteners 12. It is contemplated that component storage data device 26 may alternatively be located on an assembly tray (not shown) used to deliver or hold first and second components 18, 20, if desired.

Tightening tool 14 may be an automated torque tool capable of tightening mechanical fasteners. As is shown in FIG. 1, tightening tool 14 may include an actuator 28 in communication with a power source 30, a head portion 32 for engaging fastener 12, and an angle sensor 34 to determine the angle through which fastener 12 has been rotated. It is contemplated that tightening tool 14 may include a torque sensor in addition to or instead of angle sensor 34, if desired.

Actuator 28 may operationally communicate with power source 30 via a power line 36 and may convert at least a portion of the power output from power source 30 to mechanical energy for applying torque to fastener 12. It should be understood that power source 30 may be an air compressor, battery assembly, or any other power source capable of driving actuator 28. Depending on the type of power supplied by power source 30, actuator 28 may be an air ratchet, an AC induction motor, a brushless DC motor, a linear motor, or any other type of motor capable of driving tightening tool 14. Additionally, power line 36 may be tubing for conducting compressed air or pneumatic fluid, electrical wire for conducting electrical energy, or any other conveyance apparatus that may communicate power generated by power source 30 to actuator 28. Furthermore, it is contemplated that power source 30 may communicate with controller 22 via a communication line 38.

Head portion 32 may engage fastener 12 and be shaped and sized to torsionally grip a receiving portion 40 of fastener 12. In addition, head portion 32 may communicate with controller 22 via a communication line 42. Furthermore, head portion 32 may interface with a strain sensor 44 located on receiving portion 40 via an interface device 46. The sensed data from strain sensor 44 may be relayed to controller 22 through communication line 42.

Strain sensor 44 may emit a pulse of energy such as, for example, ultrasonic energy along an axial length of rod portion 24 and receive in return, an echo of the pulse. Strain sensor 44 may be an ultrasonic transducer or any other device known in the art capable of emitting such a pulse of energy along rod portion 24 and receiving the reflection of the pulse. It should be understood that an elongation of rod portion 24 measured by strain sensor 44 may be directly related to the strain of fastener 12.

Interface device 46 may be located within head portion 32 of tightening tool 14 to contact strain sensor 44 when head portion 32 engages receiving portion 40. Interface device 46 may receive electrical signals from controller 22 and transmit them to strain sensor 44 through an electrical contact (not shown). Furthermore, interface device 46 may receive electrical signals from strain sensor 44 and transmit them to control device 22 via communication line 42.

Receiving portion 40 may also include a fastener data storage device 48 containing data related to the installation of fastener 12. Such data may include, for example, identification of associated fastener 12, an axial load to which associated fastener 12 may be tightened, and any other factor that may help facilitate the assembly process. Fastener data storage device 48 may be a radio frequency identification device (RFID) or indicia, such as, for example, a barcode. As illustrated in FIG. 3A, fastener data storage device 48 may be an independent element located adjacent to strain sensor 44. However, FIG. 3B illustrates an alternate embodiment where non-repeating segments of code associated with the information described above, may be etched into a top layer of strain sensor 44. In addition, it is contemplated that non-repeating segments of code may be etched directly onto receiving portion 40 of fastener 12, if desired. In such embodiments, each segment of code may correspond to a different factor related to the tightening of fastener 12.

Referring to FIG. 1, a scanner 50 may be used to read data contained in component data storage device 26 and fastener data storage device 48, and may be any device capable of reading the data, such as, for example, an RFID or barcode scanner. It is contemplated that although scanner 50 is disclosed as being incorporated within a glove 52 worn by an operator, scanner 50 may alternatively be a portable, hand-held device, if desired. In addition, scanner 50 may be powered by a battery pack (not shown), or a power line (not shown) in communication with an electrical power source (not shown). Upon receiving data from component data storage device 26 and fastener data storage device 48, scanner 50 may transmit the received data to controller 22 wirelessly or via a communication line (not shown). It is contemplated that an additional scanner 54 may be included in interface device 46, if desired. Additional scanner 54 may be similar to scanner 50 and may read data from component data storage device 26 and fastener data storage device 48 while tightening tool 14 is engaged with or near head portion 40 of fastener 12.

When tightening tool 14 engages fastener 12, angle sensor 34 may sense a rotational angle of head portion 32 that is equivalent to the rotated angle of fastener 12. The rotational angle of head portion 32 may be related to a torque acting on fastener 12. It should be understood that angle sensor 34 may be any type of sensor capable of sensing the rotational angle of fastener 12. For example, angle sensor 34 may embody a magnetic pickup sensor configured to sense a rotational angle of head portion 32 and to produce a signal indicative of the angle. Angle sensor 34 may be disposed proximal a magnetic element (not shown) embedded within a rotational element (not referenced) of head portion 32, or in any other suitable manner to produce a signal corresponding to the rotational angle of head portion 32. The sensed rotational angle may be sent to controller 22 by way of communication line 42, as is known in the art. It is contemplated that in embodiments including a torque sensor, when tightening tool 14 engages fastener 12, the torque sensor may sense a torque applied to fastener 12. The sensed torque may be sent to controller 22 by way of communication line 42, as is known in the art.

Controller 22 may take many forms, including, for example, a computer based system, a microprocessor based system, a microcontroller, or any other suitable control type circuit or system. Controller 22 may also include memory for storage of a control program for operation and control of tightening tool 14, power source 30, and/or other components of assembly station 10. It is contemplated that controller 22 may reference tables, graphs, and/or equations included in its memory and use the sensed information and/or values received from component data storage device 26, angle sensor 34, strain sensor 44, and fastener data storage device 48 to regulate the operation of tightening tool 14 and power source 30. For example, controller 22 may command tightening tool 14 to disengage from fastener 12 upon a determination that a target axial load has been achieved. The determination may be made by comparing the signals received from strain sensor 44 and angle sensor 34 to tables, graphs, and/or equations included in its memory. Controller 22 may further include an output device 56 for communicating assembly instructions to an operator. Such output device may be a display or any other output device known in the art capable of communicating assembly instructions to the operator.

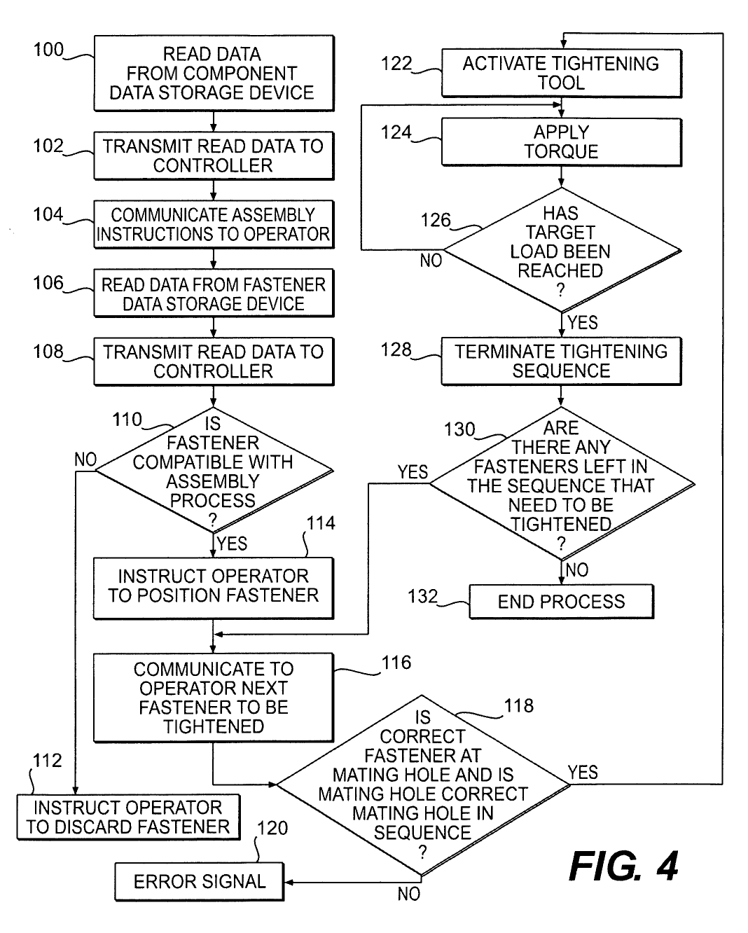

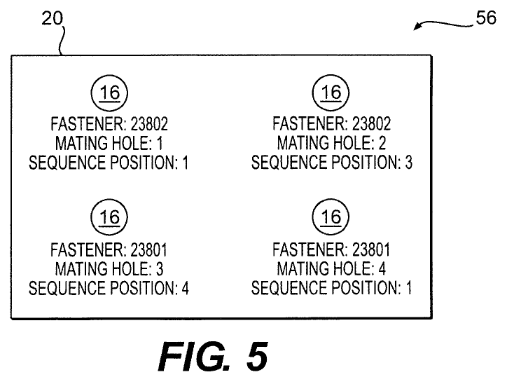

FIG. 4 illustrates an exemplary method used by controller 22 to tighten fastener 12, and FIG. 5 illustrates an exemplary graphical representation of first and second components 18, 20 and mating holes 16 used by controller 22 to communicate identification and assembly information to the operator.

### INDUSTRIAL APPLICABILITY

The disclosed assembly system may provide a secure, strong joint bound by multiple mechanical fasteners. In particular, the disclosed assembly system may ensure that all fasteners of the joint are tightened to a desired final axial load by tightening each fastener in a predetermined order based on data stored in an associated component data storage device and on the fasteners themselves. Such tightening order may reduce the effect each fastener has on the axial loads of previously tightened fasteners. In addition, each fastener may be tightened more than once before achieving a final axial load. This strategy may reduce the likelihood of fasteners having an undesired final axial load due to undetected changes during the tightening of subsequent fasteners.

Before activating assembly system 10, an operator may position first and second components 18, 20 for assembly. After positioning first and second components 18, 20, the operator may manually activate scanner 50. The activation of scanner 50 may be performed by operating an input device (not shown) such as, for example, a button, a trigger, or a switch. The operation of assembly system 10 may begin when scanner 50 is activated and will now be explained.

As illustrated in FIG. 4, the method may begin when the operator aims scanner 50 at any component data storage device 26, and the data encoded thereon is electronically received (step 100). It should be understood that if scanner 50 is an RFID scanner, scanner 50 may be able to read data encoded on component data storage device 26 by simply entering a zone about component data storage device 26 without being manually aimed and actuated. Scanner 50 may transmit the read data to controller 22 (step 102) where it may be used to instruct the operator regarding assembly procedures and control the operation of tightening device 14. After receiving data from component data storage device 26, controller 22 may communicate instructions regarding assembly procedures via output device 56 (step 104).

An exemplary instructional communication is illustrated in FIG. 5. The communication may indicate a need for two bolts identified as 23802 with an initial axial load of 7.5 Nm and a final axial load of 8 Nm and two bolts 23801 with an initial axial load 7.0 Nm and a final axial load 8.5 Nm. Additionally, the communication may indicate at which mating holes 16 to position the bolts and in what specific sequence they shall be tightened. Fore example, the first 23082 fastener may be required at mating holed 1, in the upper left corner of component 20 and be first in the tightening sequence. The second 230802 fastener may be required at mating hole 2 in the upper right corner of component 20 and be third in the tightening sequence. Additionally, the first 23801 fastener may be required at mating hole 3 in the lower left corner of component 20 and be fourth in the tightening sequence. Furthermore, the second 23801 fastener may be required at mating hole 4 in the lower right corner of component 20 and be second in the sequence.

Although FIG. 5 illustrates such communication as a graphical representation of first and second components 18, 20 with associated mating holes 16, it is contemplated that the communication may alternately be a symbolic representation, an audible instruction, or any other method known in the art to communicate instructions to the operator, if desired. In addition, it should be understood that fasteners 12 may have a unique identification mark or share an identification mark with other fasteners 12 having similar characteristics such as, for example, size or threading geometry. Furthermore, mating holes 16 and fasteners 12 may have intervening target axial loads that may occur in the tightening sequence between the initial target axial load and the final axial load.

After receiving an instructional communication from controller 22, the operator may select a fastener 12 from one or more batches of available fasteners and again manually activate scanner 50. The activation of scanner 50 may be performed by operating an input device (not shown) as disclosed above. After activation, the operator may aim scanner 50 at fastener data storage device 48, and the data encoded thereon is electronically received (step 106). As is disclosed above, it should be understood that if scanner 50 is an RFID scanner, scanner 50 may be able to read data encoded on fastener data storage device 48 by simply entering a zone about component data storage device 26 without being aimed. Scanner 50 may transmit the read data to controller 22 (step 108) where it may be used to verify that the selected fastener 12 is compatible with the assembly process (step 110).

Controller 22 may verify the compatibility of the selected fastener 12 by comparing the data read from fastener data storage device 48 with data read from component data storage device 26. In an alternate embodiment, the identification information may be compared to a database or other referencing device independently inputted into controller 22. If controller 22 determines that fastener 12 is incompatible with the assembly process (step 110: No), controller 22 may instruct the operator to discard fastener 12 (step 112). After discarding the incompatible fastener 12, the operator may select another fastener 12, activate scanner 50, and step 106 may be repeated.

If controller 22 determines that fastener 12 is compatible with the assembly process (step 110: Yes), controller 22 may instruct the operator to position the selected fastener 12 for assembly (step 114). It should be understood that in situations requiring only one type of fastener 12, the exact position of each fastener 12 may be unimportant to the integrity of the joint, and fastener 12 may be positioned at any mating hole 16. For example, if controller 22 indicates that all mating holes 16 shall receive fasteners 12 identified by model number 23802, the operator may place fasteners 12 at any mating hole 16 without referencing instructions communicated by controller 22 via output device 56. It is also contemplated that assembly system 10 may be an autonomous system controlling the positioning of fasteners 12 and the motion of tightening tool 14, if desired.

After the operator manually positions fastener 12 at the prescribed mating hole 16, other fasteners 12 may be manually selected and steps 106 through 112 may be repeated until all fasteners 12 required to secure first and second components 18, 20 together are positioned at a prescribed mating hole 16. When all fasteners 12 are positioned for assembly, controller 22 may communicate to the operator via output device 56, which fastener 12 is the first to be tightened in the tightening sequence (step 116). Controller 22 may determine which fastener 12 is first in the tightening sequence from the data read from component data storage device 26 and may communicate the information to the operator in a similar manner, as disclosed above. For example, controller 22 may indicate that fastener 12 positioned at the mating hole labeled as 4 is the first fastener 12 in the sequence to be tightened.

The operator may manually place tightening tool 14 at an engagement position relative to fastener 12. When fastener 12 is engaged, the operator may manually activate scanner 50 in the manner disclosed above. Scanner 50 may read data from component data storage device 26 and fastener data storage device 48 and transmit the identity of mating hole 16 and fastener 12 to controller 22. Upon receiving data from scanner 50, controller 22 may verify that fastener 12 is positioned at the correct mating hole 16 and is the next fastener 12 to be tightened in the tightening sequence (step 118). It is contemplated that, alternatively, additional scanner 54 may be automatically activated when interface device 46 comes into contact with strain sensor 44, if desired. Additional scanner 54 may then read data from component data storage device 26 and fastener data storage device 48 and transmit the identity of mating hole 16 and fastener 12 to controller 22. If controller 22 determines that either fastener 12 is positioned at an incorrect mating hole 16 or that fastener 12 is not the next fastener 12 to be tightened in the tightening sequence (step 118: No), then controller 22 may signal an error (step 120) to the operator though display device 56. Such error signal may indicate that an incorrect fastener 12 has been positioned at mating hole 16, that fastener 12 is not the next fastener 12 to be tightened in the tightening sequence, or both. When an error signal is indicated, the operator may reposition tightening tool 14 at another mating hole 16 or position another fastener 12 at mating hole 16, depending on the error indicated. For example, upon determining an error, controller 22 may produce an audible alarm, highlight the incorrect mating hole 16 displayed on output device 56, or create some other kind of indication capable of informing the operator that an error has occurred.

If controller 22 verifies that both the correct fastener 12 is positioned at mating hole 16 and that fastener 12 is the next fastener to be tightened in the sequence (step 116: Yes), then controller 22 may activate tightening tool 14 (step 120). Once activated, tightening tool 14 may begin applying an increasing torque to receiving portion 40, thereby causing fastener 12 to rotate (step 122). While fastener 12 is being tightened, controller 22 may send a command signal to strain sensor 44 via interface device 46 to begin emitting an ultrasonic pulse along rod portion 24 of fastener 12. Upon receiving an echo of the ultrasonic pulse, strain sensor 44 may send an electronic signal indicative of the travel time of the pulse and its echo to controller 22 via interface device 46. At the same time, controller 22 may receive a signal from angle sensor 34 indicative of the rotational angle of fastener 12. Controller 22 may use the signals from angle sensor 34 and strain sensor 44 to determine the rotational angle and elongation of fastener 12, respectively. It should be understood that the tightening of fastener 12 may be measured via methods other than ultrasonic measurement. For example, fastener 12 may include a strain gauge and/or tightening tool may include a torque sensor. Controller 22 may receive signals from the sensors and use the signals to determine the strain of fastener 12 and/or the torque applied to fastener 12.

While applying torque to fastener 12, controller 22 may determine whether a target axial load for the current application of torque has been reached by comparing the determined rotational angle and elongation and torque to graphs, charts, or tables representing elastic deformation and axial load values for fastener 12 (step 124). It should be understood that the target axial load for the current application of torque may not be the final target axial load. For example, the tightening sequence may call for fasteners 12 to initially be only partially tightened before moving on to the next fastener 12 in the sequence. Upon a second or third application of torque, fasteners 12 may be tightened to a final axial load. If the axial load is less than the target axial load for the current application of torque (step 124: No), then tightening tool 14 may continue applying an increasing torque to fastener 12. However, if the axial load of fastener 12 is essentially equivalent to the target axial load for the current application of torque (step 124: Yes), then controller 22 may send a signal to power source 30 and tightening tool 14 to terminate the tightening of fastener 12 (step 126).

Upon terminating the tightening of fastener 12, controller 22 may record in its memory that the particular tightening step has been completed. Controller 22 may then reference data read from component data storage device 26 to see if any fasteners 12 need further tightening to reach their assigned final axial loads (step 128). If it is determined that there are fasteners 12 that need further tightening (step 128: Yes), then controller 22 may communicate to the operator which fastener 12 is to be tightened next in the tightening sequence (step 114). However, if it is determined that all fasteners 12 have been tightened to their prescribed final axial loads (step 128: No), then the tightening process may be terminated (step 130).

The fastener tightening system and method disclosed above may accurately tighten multiple fasteners to a predetermined final axial load. By tightening the fasteners in a particular sequence, the system may address the relational effect each fastener has on each other. In particular, because the system may make multiple tightening attempts for each fastener, undesired axial load changes due to the tightening of other fasteners may be minimized.

Additionally, because each fastener may be identified by the system, different magnitudes of torque can be applied to different fasteners by the same torque tool. Thus, the system may rely on the unique identification of each fastener rather than differing physical characteristics between fasteners when determining the magnitude of torque to apply. In such a system, fasteners having different physical characteristics as well as fasteners having similar physical characteristics can be tightened to a unique axial load.

Furthermore, because each fastener may be uniquely identified by the system, manufacturing errors due to incompatible fasteners can be reduced. The system may be able to detect characteristics of each fastener through the disclosed identification device. This may allow the system to screen out fasteners having characteristics incompatible with the joint being created. Such characteristics may be, for example, incorrect size, incorrect threading geometry, incorrect material, or any other characteristic that may be important to the integrity of the joint.

It will be apparent to those skilled in the art that various modifications and variations can be made in the disclosed system without departing from the scope of the disclosure. Other embodiments will be apparent to those skilled in the art from consideration of the specification disclosed herein. It is intended that the specification and examples be considered as exemplary only, with a true scope being indicated by the following claims and their equivalents.

What is claimed is:

1. A fastener tightening system comprising:
a tightening tool configured to apply torque to a fastener;
a fastener data storage device located on the fastener to store data related to the associated fastener;
at least one component data storage device located on a component receiving the fastener to store data related to a tightening process;
a data sensor configured to sense data stored on the fastener data storage device and the at least one component data storage device; and
a controller configured to regulate operation of the tightening tool based on the sensed data and the sensed parameter.

2. The fastener tightening system of claim 1, wherein the at least one component data storage device is located adjacent to a mating hole receiving the fastener.

3. The fastener tightening system of claim 2, wherein the tightening tool is configured to apply a first torque to the fastener until the axial load acting on the fastener is approximately equal to an initial target axial load, the initial target axial load being determined from the data stored on the at least one component data storage device.

4. The fastener tightening system of claim 3, wherein the tightening tool is configured to apply a subsequent torque to the fastener until the axial load acting on the fastener is approximately equal to a final target axial load, the final target axial load being determined from data stored on the at least one component data storage device.

5. The fastener tightening system of claim 4, wherein the tightening tool is configured to apply the first and subsequent torques to multiple fasteners in a predetermined sequence determined from data stored on the at least one component data storage device.

6. The fastener tightening system of claim 1, wherein the at least one component data storage device is a radio frequency identification device.

7. The fastener tightening system of claim 1, wherein the at least one component data storage device is a coded indicia.

8. The fastener tightening system of claim 1, wherein the fastener data storage device is a radio frequency identification device.

9. The fastener tightening system of claim 1, wherein the fastener data storage device is a coded indicia.

10. A method for tightening a fastener comprising:
reading data stored on a component and the fastener;
applying a first torque to the fastener based on the read data;
adjusting the magnitude of the applied first torque based on the read data;
applying a subsequent torque to the fastener based on the read data; and
adjusting the magnitude of the applied subsequent torque based on the read data.

11. The method of claim 10, further including applying the first and subsequent torques to multiple fasteners in a predetermined sequence based on the read data.

12. The method of claim 11, further including sensing at least one parameter indicative of a first and a subsequent axial load acting on the fastener.

13. The method of claim 12, further including adjusting the magnitude of the applied first torque based on the at least one parameter.

14. The method of claim 13, further including applying the first torque to the fastener until the first axial load acting on the fastener is essentially equivalent to a target initial axial load.

15. The method of claim 14, further including applying the subsequent torque to the fastener until the subsequent axial load acting on the fastener is essentially equivalent to a target final axial load.

16. A fastener tightening system comprising:
a tightening tool configured to apply a torque to a fastener;
a strain sensor configured to sense a parameter of the fastener indicative of an elongation of the fastener;
a stress sensor configured to sense a parameter of the fastener indicative of the magnitude of an applied torque;
a fastener data storage device located on the fastener to store identification data to identify the associated fastener;
at least one component data storage device located on a component receiving the fastener to store data related to a tightening process;
a controller configured to determine a tightening sequence, an initial target axial load, and multiple subsequent target axial loads based on the sensed data, and regulate operation of the tightening tool based on the determined tightening sequence, initial target axial load, and subsequent target axial load.

17. The fastener tightening system of claim 16, wherein the tightening tool is configured to apply a first torque to the fastener until the axial load acting on the fastener is approximately equal to the determined initial target axial load.

18. The fastener tightening system of claim 17, wherein the tightening tool is configured to apply multiple subsequent torques to the fastener until the axial load acting on the fastener is approximately equal to a final target axial load determined from the sensed data.

19. The fastener tightening system of claim 18, wherein the tightening tool is configured to apply the first and subsequent torques to the multiple fasteners in the predetermined sequence.

20. The fastener tightening system of claim 19, wherein the fastener data storage device and at least one component data storage device is one of a radio frequency identification device and a coded indicia.
